(19) United States
(12) Patent Application Publication
(10) Pub. No.: US 2025/0162728 A1
(43) Pub. Date: May 22, 2025

(54) ARTICULATING TRANSPORT ASSEMBLY AND A TRANSPORT SYSTEM UTILIZING THE ASSEMBLY

(71) Applicant: The Boeing Company, Arlington, VA (US)

(72) Inventors: Christopher Michael Vitro, Seattle, WA (US); Charles M. Richards, Kent, WA (US); Yasmine D. Pourarian, Edmonds, WA (US); James J. Troy, Issaquah, WA (US); Simon Deshusses, New York, NY (US); Daniel M. Simunovic, Titusville, FL (US)

(73) Assignee: The Boeing Company, Arlington, VA (US)

(21) Appl. No.: 18/512,637

(22) Filed: Nov. 17, 2023

(51) Int. Cl. B64F 1/32

(52) U.S. Cl. CPC B64F 1/32

(57) ABSTRACT

An articulating transport assembly for a movable platform includes a plurality of arm segments connected to each other. The arm segments are movable to a retracted state and an extended state to define an articulating arm. The articulating transport assembly also includes a plurality of joints, and each of the joints include a first connector and a second connector disposed between a respective pair of the arm segments to join the arm segments such that the arm segments move relative to each other with a single degree-of-freedom between the retracted state and the extended state. A transport system for moving a flexible structure includes an aircraft including a port configured to connect to the flexible structure and the articulating transport assembly to move the flexible structure.

### BACKGROUND

Generally, it is desirable to provide power and/or fluid to an aircraft on a flight line. One way to provide power/water to the aircraft is to manually pull a cable/hose out to the aircraft. For example, the cable/hose may be stretched across rolling carts, and the rolling carts are manually pulled to the aircraft. However, pulling the cable/hose and/or the rolling carts to the aircraft is labor intensive and may cause wear to the cable/hose.

### SUMMARY

Therefore, it is desirable to develop an articulating transport assembly and a transport system that moves an object to a desired location while providing stability and predictable movement and reducing wear to the object, but without manually moving the object.

The present disclosure provides an articulating transport assembly for a movable platform. The articulating transport assembly includes a plurality of arm segments connected to each other. The arm segments are movable to a retracted state and an extended state to define an articulating arm. The articulating transport assembly also includes a plurality of joints, and each of the joints include a first connector and a second connector disposed between a respective pair of the arm segments to join the arm segments such that the arm segments move relative to each other with a single degree-of-freedom between the retracted state and the extended state.

The present disclosure provides a transport system for moving a flexible structure. The transport system includes an aircraft and an articulating transport assembly. The aircraft includes a port configured to connect to the flexible structure. The articulating transport assembly includes a plurality of arm segments connected to each other. The arm segments are movable to a retracted state and an extended state to define an articulating arm configured to support and move the flexible structure relative to the aircraft. The articulating transport assembly includes a plurality of joints, and each of the joints include a first connector and a second connector disposed between a respective pair of the arm segments to join the arm segments such that the arm segments move relative to each other with a single degree-of-freedom between the retracted state and the extended state.

The detailed description and the drawings or FIGS. are supportive and descriptive of the disclosure, but the claim scope of the disclosure is defined solely by the claims. While some of the best modes and other configurations for carrying out the claims have been described in detail, various alternative designs and configurations exist for practicing the disclosure defined in the appended claims.

### BRIEF DESCRIPTION OF THE DRAWINGS

FIG. 1 is a schematic illustration of a transport system utilizing an articulating transport assembly, in which an object is disposed on a platform of the articulating transport assembly.

FIG. 2 is a schematic top view of the articulating transport assembly in a retracted state.

FIG. 3 is a schematic top view of the articulating transport assembly in an extended state.

FIG. 4 is a schematic top view of the articulating transport assembly in the extended state illustrating a desired alignment region (in evenly spaced dashed lines) of a distal arm segment.

FIG. 5 is a schematic fragmented top view of the articulating transport assembly in the retracted state with a platform removed to see the components of a first configuration thereunder.

FIG. 6 is a schematic enlarged view of a joint taken from region 6 of FIG. 5.

FIG. 7 is a schematic enlarged view of the joint of FIG. 6 moved in the extended state.

FIG. 8 is a schematic enlarged view of the joint taking from region 8 of FIG. 9.

FIG. 9 is a schematic fragmented top view of the articulating transport assembly in the extended state of the first configuration of FIG. 5.

FIG. 10 is a schematic enlarged fragmented view of the joint of FIGS. 5-9.

FIG. 11 is a schematic fragmented side view of the articulating transport assembly illustrating links relative to arm segments.

FIG. 12 is a schematic top view of the articulating transport assembly of a second configuration in the retracted state.

FIG. 13 is a schematic top view of the articulating transport assembly of the configuration of FIG. 12 in the extended state.

FIG. 14 is a schematic top view of the articulating transport assembly of a third configuration in the retracted state.

FIG. 15 is a schematic top view of the articulating transport assembly of the configuration of FIG. 14 in the extended state.

FIG. 16 is a schematic side view of the articulating transport assembly with an end effector in a stored state, with the platform removed.

FIG. 17 is a schematic top view of the articulating transport assembly of FIG. 16.

FIG. 18 is a schematic perspective view of the articulating transport assembly in the retracted state.

FIG. 19 is a schematic fragmented side view of the distal arm segment with the end effector in the stored state.

FIG. 20 is a schematic fragmented side view of the distal arm segment with the end effector of FIG. 19 with the end effector in a partial deployed state.

FIG. 21 is a schematic end view of the distal arm segment of FIG. 20 with the end effector in the partial deployed state.

FIG. 22 is a schematic end view of the distal arm segment of FIG. 21 with a post elevated to lift the object in the direction of arrow W.

The present disclosure may be extended to modifications and alternative forms, with representative configurations shown by way of example in the drawings and described in detail below. Inventive aspects of the disclosure are not limited to the disclosed configurations. Rather, the present disclosure is intended to cover modifications, equivalents, combinations, and alternatives falling within the scope of the disclosure as defined by the appended claims.

### DETAILED DESCRIPTION

Those having ordinary skill in the art will recognize that all directional references (e.g., above, below, upward, up, downward, down, top, bottom, left, right, vertical, horizontal, etc.) are used descriptively for the FIGS. to aid the reader's understanding, and do not represent limitations (for example, to the position, orientation, or use, etc.) on the scope of the disclosure, as defined by the appended claims. Moreover, terms such as “first,” “second,” “third,” and so on, may be used to describe separate components. Such terminology may include the words specifically mentioned above, derivatives thereof, and words of similar import. Furthermore, the term “substantially” can refer to a slight imprecision or slight variance of a condition, quantity, value, or dimension, etc., some of which are within manufacturing variance or tolerance ranges.

As used herein, an element or step recited in the singular and preceded by the word “a” or “an” should be understood as not necessarily excluding the plural of the elements or steps. Further, any reference to “one configuration” is not intended to be interpreted as excluding the existence of additional configurations that also incorporate the recited features. Moreover, unless explicitly stated to the contrary, configurations “comprising” or “having” an element or a plurality of elements having a particular property may include additional elements not having that property. The phrase “at least one of” as used herein should be construed to include the non-exclusive logical “or”, i.e., A and/or B and so on depending on the number of components.

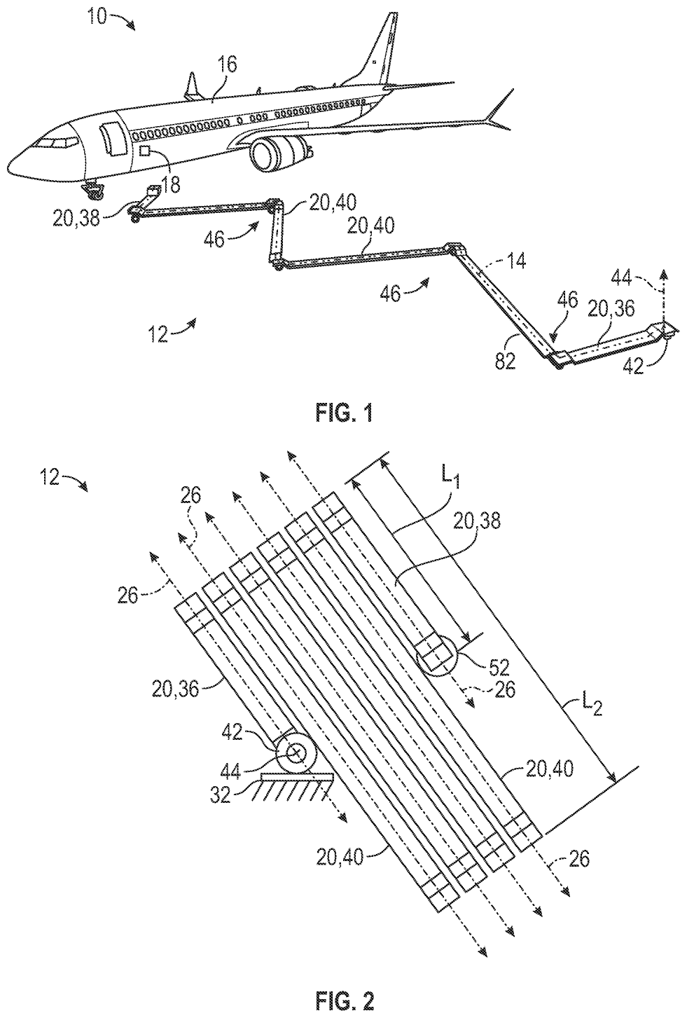

Referring to the figures, wherein like numerals indicate like or corresponding parts throughout the several views, a transport system 10 and an articulating transport assembly 12 utilized in the transport system 10 are generally shown in FIG. 1. As discussed herein, the articulating transport assembly 12 provides stability and predictable movement that may be automated.

Generally, the transport system 10 may be used for moving an object 14 from one location to another location. Specifically, the transport system 10 may utilize the articulating transport assembly 12 to move the object 14. For example, in certain situations it may be desirable to move the object 14 towards and away from one or more machines, vehicles, equipment, buildings, etc., to perform various tasks. Therefore, the transport system 10 may be used in various environments and move various objects 14 depending on the environment. Non-limiting examples of the objects 14 are described below.

The articulating transport assembly 12 may be for a movable platform 16. That is, the articulating transport assembly 12 is utilized to move the object 14 toward the movable platform 16 such that the object 14 may be used to perform a task with the movable platform 16, and when the task is completed, the articulating transport assembly 12 is utilized to move the object 14 away from the movable platform 16. It is desirable for the articulating transport assembly 12 to use a path to and from the movable platform 16 that is direct and uninterrupted.

The movable platform 16 may be any suitable configuration, and one non-limiting example is a vehicle, which may include an aircraft, a drone, a spacecraft, a train, a car, a truck, farm equipment, a watercraft, etc., or any other suitable movable platform 16. It is to be appreciated that the articulating transport assembly 12 may be utilized to move the object 14 toward/away from other items, whether stationary or not, such as, machines, equipment, and buildings, which may include pumps, generators, tanks, etc., or any other suitable items.

Turning back to the object 14, the object 14 may be any suitable configuration for performing the desired task. For example, the object 14 may be a flexible structure. Therefore, the transport system 10 may be for moving the flexible structure. Non-limiting examples of the flexible structure may include a cable, a hose, a conduit, a sleeve, etc. Therefore, the object 14 may be a cable that provides power to an aircraft when the cable is attached to a port 18 of the aircraft. As such, the transport system 10 may include the aircraft having the port 18 configured to connect to the flexible structure. The port 18 may be an inlet, an outlet, or any other suitable connection to the aircraft. As another example, the object 14 may be a hose or a conduit that provides a fluid to the aircraft when the hose is attached to the port 18 of the aircraft. Therefore, in certain configurations, the fluid may be water directed through the hose and delivered to a storage tank in the aircraft. For illustrative purposes for the discussion below, the movable platform 16 will periodically be referred to as the aircraft and the object 14 will periodically be referred to as the cable.

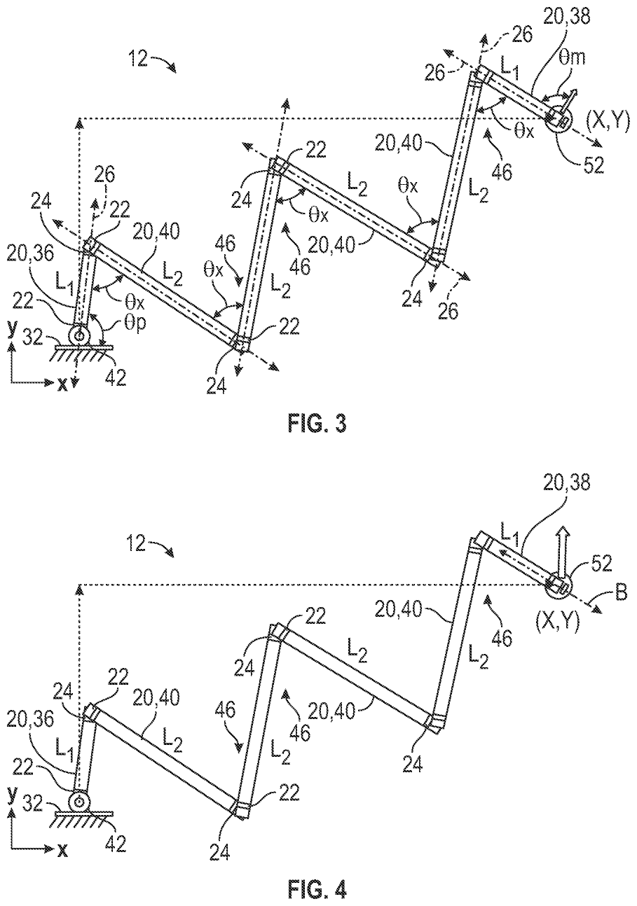

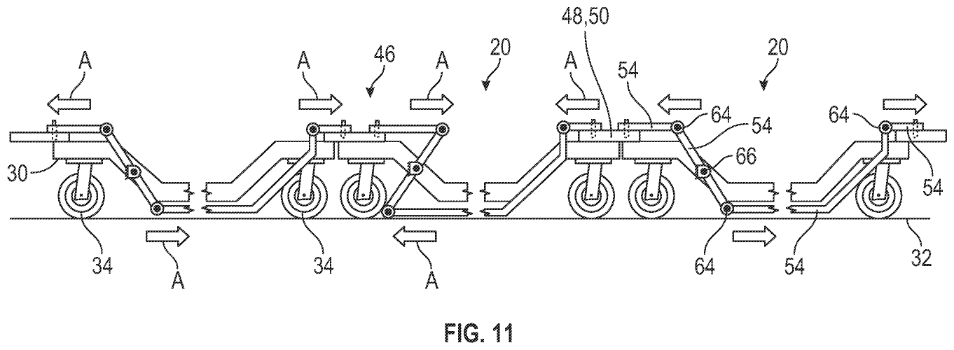

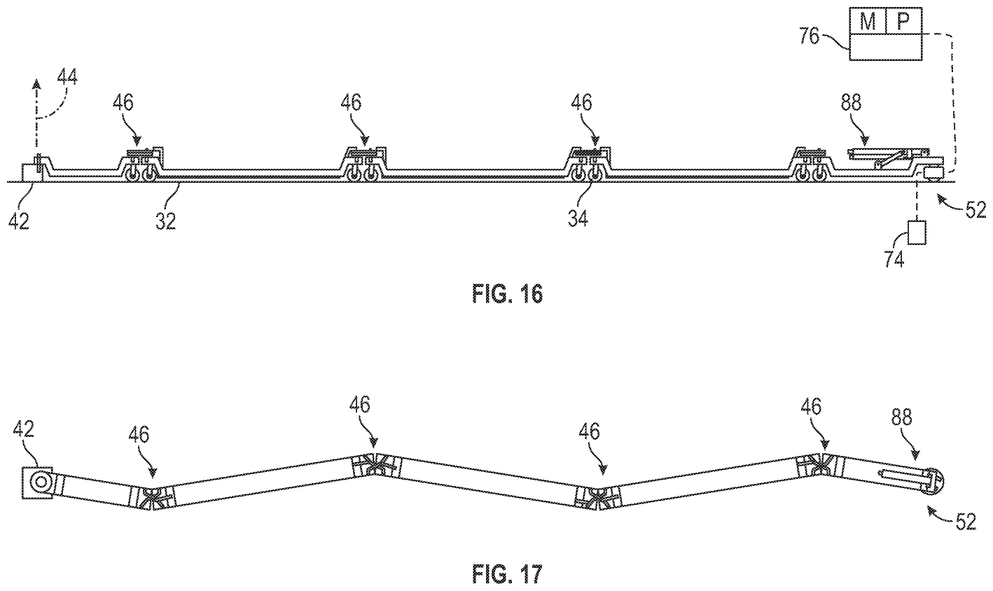

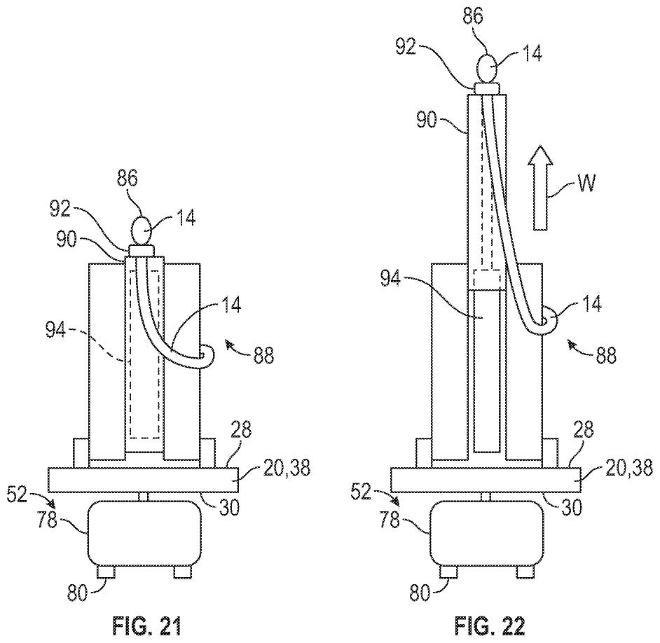

Referring to FIGS. 2 and 3, the articulating transport assembly 12 further includes a plurality of arm segments 20 connected to each other. Each of the arm segments 20 may include a first end 22 and a second end 24 opposing each other along a central axis 26. Therefore, generally, the first end 22 of one of the arm segments 20 is coupled to the second end 24 of another one of the arm segments 20. In addition, the arm segments 20 may include a first side 28 and a second side 30 opposing the first side 28 (numbered in FIGS. 21 and 22). The second side 30 of each of the arm segments 20 may face the ground 32 (see FIGS. 11 and 16 for an illustration of the ground 32 relative to the arm segments 20).

The arm segments 20 are movable to a retracted state (see FIG. 2) and an extended state (see FIG. 3) to define an articulating arm. As discussed further below, the arm segments 20 are connected via various components to mechanically constrain motion which allow for predictive and deterministic extension and retraction. That is, when any of the arm segments 20 are moved, each of the arm segments 20 moves in a similar manner with respect to each other.

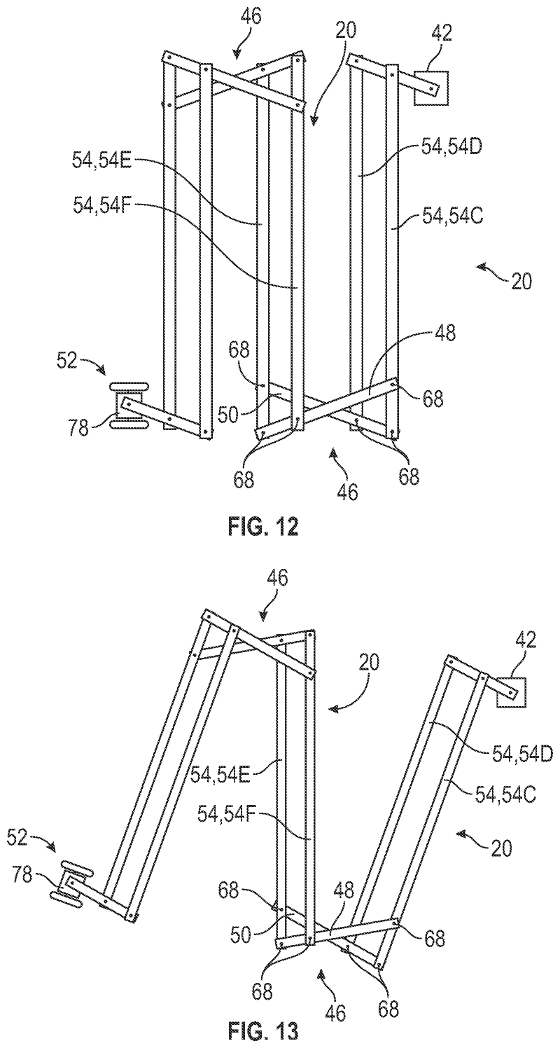

As best shown in FIG. 11, for all of the configurations herein, the articulating transport assembly 12 may include at least one ground support 34 attached to the second side 30 of each of the arm segments 20 to support the arm segments 20. The ground support 34 of each of the arm segments 20 may engage the ground 32 to support the arm segments 20. The ground support 34 of each of the arm segments 20 may be any suitable configuration, and any suitable number of ground support 34 may be used. That is, a plurality of ground support 34 may be attached to the second side 30 of each of the arm segments 20, and each of the ground support 34 may be a foot/feet, a wheel, a continuous track, a sliding foot pad, etc., or any other suitable structure to allow movement of the arm segments 20, such as the predictable and deterministic movement described herein. Even though the ground support 34 are not illustrated in FIGS. 12-15, it is to be appreciated that one or more ground support 34 may be disposed along the second side 30 of each of the arm segments 20 of FIGS. 12-15 as shown in FIG. 11.

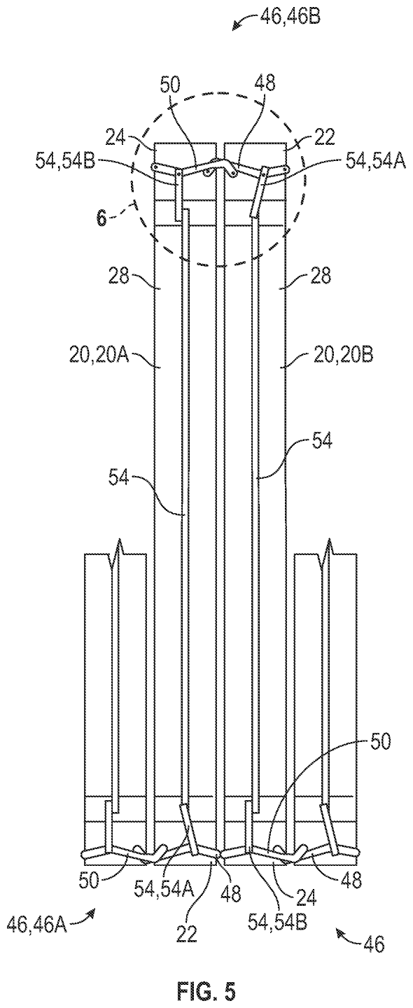

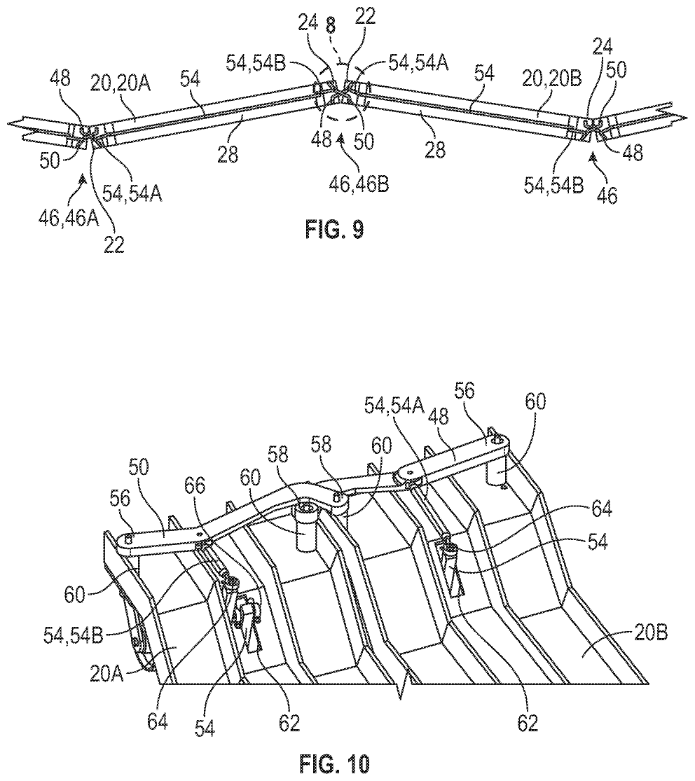

In certain configurations, the articulating arm is configured to support and move the flexible structure relative to the aircraft. For example, when the arm segments 20 are in the retracted state, this may be when the articulating arm is being stored or awaiting use. When the arm segments 20 are in the extended state, this may be when the articulating arm is being used, either extending the cable to the aircraft to plug the cable into the aircraft or retracting the cable back toward the retracted state when use of the cable has been completed. Other figures also illustrate the retracted state and the extended state, in which FIGS. 5, 10, 12, 14, and 18 illustrate the retracted state and FIGS. 1, 4, 9, 11, 13, and 15-17 illustrate the extended state.

In certain configurations, one of the arm segments 20 may be defined as a proximal arm segment 36 and another one of the arm segments 20 may be defined as a distal arm segment 38. In certain configurations, at least one of the arm segments 20 may be disposed between the proximal arm segment 36 and the distal arm segment 38. Therefore, in certain configurations, the at least one of the arm segments 20 disposed between the proximal arm segment 36 and the distal arm segment 38 is defined as an intermediate arm segment 40.

Depending on the number of the arm segments 20 being used, the distal arm segment 38 may be directly coupled to the proximal arm segment 36 or the distal arm segment 38 may be spaced from the proximal arm segment 36 via one or more of the intermediate arm segments 40. For illustrative purposes, the figures illustrate at least one intermediate arm segment 40 disposed between the proximal arm segment 36 and the distal arm segment 38.

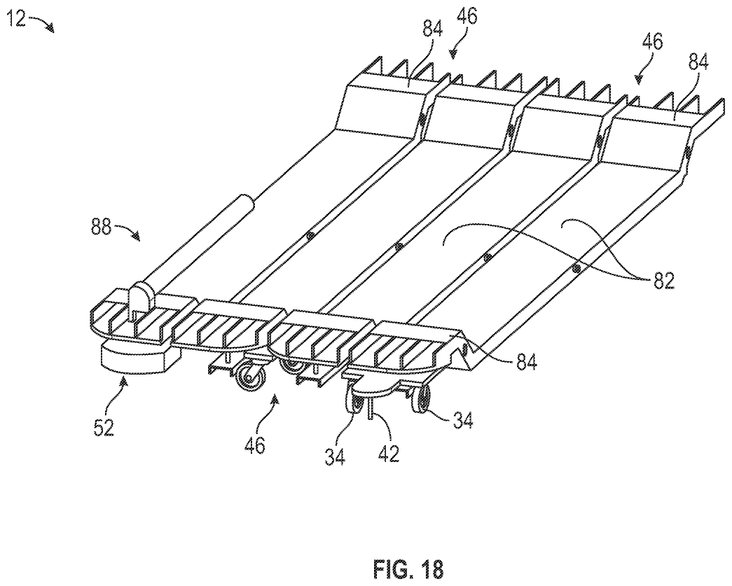

Generally, each of the arm segments 20 has a length L₁, L₂. In certain configurations, the length L₁ of the proximal arm segment 36 and the distal arm segment 38 are different than the length L₂ of the intermediate arm segment 40 (see FIGS. 2-4 as examples). In certain configurations, the proximal arm segment 36 and the distal arm segment 38 include a first length L₁, and the intermediate arm includes a second length L₂ greater than the first length L₁. In other configurations, the first length L₁ and the second length L₂ are the same (see FIG. 18). In yet other configurations, the first length L₁ is greater than the second length L₂. Having different lengths of the proximal arm segment 36 and the distal arm segment 38 as compared to the intermediate arm segment 40 may be useful for storage purposes and/or space savings when the articulating arm is being stored.

Generally, for all of the configurations herein, in certain situations, the proximal arm segment 36 may be anchored, such as to the ground 32 or any other suitable stationary structure. Referring to FIGS. 3, 12, and 14, the articulating transport assembly 12 may include an anchor point 42 coupled to the proximal arm segment 36. In certain configurations, each of the arm segments 20 are movable relative to each other with the single degree-of-freedom and also with the single degree-of-freedom relative to the anchor point 42. As such, the anchor point 42 may define a pivot axis 44, and the proximal arm segment 36 is coupled to the anchor point 42 such that the proximal arm segment 36 is rotatable about the pivot axis 44 to selectively change a location of the distal arm segment 38 relative to the anchor point 42. That is, the articulating arm is movable between the retracted state and the extended state relative to the anchor point 42, and thus, the articulating arm may translate and/or rotate relative to the pivot axis 44. In certain configurations, the first end 22 of one of the arm segments 20, i.e., the proximal arm segment 36, is coupled to the anchor point 42. Therefore, the proximal arm segment 36 is disposed closer to the anchor point 42 than the distal arm segment 38. In certain configurations, the entire articulating arm may be movable to a desired location before the proximal arm segment 36 is anchored, which will be discussed further below.

As best shown in FIGS. 5-10 and 12-15, the articulating transport assembly 12 also includes a plurality of joints 46. Generally, one of the joints 46 is disposed between a respective pair of the arm segments 20 to connect each of the arm segments 20 together. In certain configurations, each of the joints 46 includes a first connector 48 and a second connector 50 disposed between the respective pair of the arm segments 20 to join the arm segments 20 such that the arm segments 20 move relative to each other with the single degree-of-freedom between the retracted state and the extended state. With the arm segments 20 moving relative to each other with the single degree-of-freedom, this provides stability and predictable motion of the articulating arm. When referring to the retracted state and the extended state, these states include translational movement and/or rotational movement.

In certain configurations, the plurality of joints 46 may include a first joint 46A and a second joint 46B. Each of the first joint 46A and the second joint 46B include the respective first connector 48 and the respective second connector 50. Therefore, the number of arm segments 20 being used will dictate the number of joints 46 for that configuration. For illustrative purposes, referring to FIG. 3, there are six arm segments 20 and several joints 46, but this number may be different. As such, it is to be appreciated that the discussion herein applies to any number of arm segments 20 and any number of joints 46.

Referring to FIG. 3, an angle θx at each of the joints 46 are substantially equal to each other during movement of the articulating arm between the retracted state and the extended state. Therefore, movement of the arm segments 20 may be synchronized, and thus, movement of the arm segments 20 may be predictable and deterministic. Angle θm in FIG. 3 is illustrative of the angle of the central axis 26 of the distal arm segment 38 relative to the direction of the movement of a transport actuator 52, the transport actuator 52 is discussed in detail further below. Furthermore, angle θp in FIG. 3 is illustrative of the angle of the central axis 26 of the proximal arm segment 36 relative to a plane that intersects the ground 32 proximal to the anchor point 42. Generally, the angle θp and the angle θx are different angles from each other.

Turning to FIG. 2, the central axis 26 of each of the arm segments 20 along the respective joints 46 are disposed substantially parallel to each other when the articulating arm is in the retracted state. Therefore, when the articulating arm is in the retracted state, each of the arm segments 20 along the respective joints 46 are disposed at the angle θx of about one-hundred eighty degrees relative to each other.

The central axis 26 of each of the arm segments 20 along the respective joints 46 are disposed transverse to each other when the articulating arm is in the extended state, i.e., the arm segments 20 are not disposed parallel to each other when in the extended state. As such, the central axis 26 of each of the arm segments 20 along the respective joints 46 are disposed at the angle θx not equal to zero degrees and not equal to one-hundred eighty degrees relative to each other when the articulating arm is in the extended state. As the arm segments 20 extend or retract relative to each other with the single degree-of-freedom, the angle θx at each of the joints 46 between the respective arm segments 20 is substantially the same to each other, i.e., equal to each other, at any given point in time.

The joints 46 may be connected by any suitable number of components and any suitable configuration. Non-limiting examples of some suitable configurations of the joints 46 are shown in FIGS. 5-10 and 12-15. For example, as shown in FIGS. 5-10, 12, and 13, the first connector 48 and the second connector 50 of each of the arm segments 20 may be defined as a link. Furthermore, the link of each of the first connector 48 and the second connector 50 may be different configurations (compare the links of FIGS. 5-10 with the links of FIGS. 12 and 13 for the first connector 48 and the second connector 50), and therefore, it is to be appreciated that the link for the first connector 48 and the second connector 50 may be any suitable configuration. As another example, as shown in FIGS. 12 and 13, the first connector 48 and the second connector 50 of each of the arm segments 20 may be defined as a gear. Each of these configurations will be discussed below.

Referring to FIGS. 5, 12, and 14, the articulating transport assembly 12 may further include a plurality of links 54. At least one of the plurality of links 54 is attached to the first connector 48 of one of the joints 46 and attached to the second connector 50 of another one of the joints 46 such that the links 54 constrain relative motion between the arm segments 20. By constraining relative motion of the arm segments 20, stability and predictable motion of the articulating arm is achieved. Regardless of the configuration of the joints 46 and the links 54 described herein, the same basic principle is achieved by these configurations, which is the movement of the arm segments 20 relative to each other with the single degree-of-freedom. The links 54 may be a different configuration than the first connector 48 and the second connector 50.

Turning to FIGS. 5-11, one example configuration of the links 54 and the first connector 48 and the second connector 50 is illustrated. In this configuration, the first connector 48 and the second connector 50 cross each other to generally define a X-configuration, which may also be referred to as a 4-bar linkage arranged in an anti-parallelogram configuration. The first connector 48 and the second connector 50 of each of the joints 46 may be attached to respective ends 22, 24 of the respective arm segments 20. More specifically, the first connector 48 and the second connector 50 cross each other over the first joint 46A such that the first connector 48 is movably attached to a first pair of ends 22, 24 of the arm segments 20 and the second connector 50 is movably attached to the first pair of ends 22, 24 of the arm segments 20. Another first connector 48 and another second connector 50 cross each other over the second joint 46B such that the first connector 48 is movably attached to a second pair of ends 22, 24 of the arm segments 20 and the second connector 50 is movably attached to the second pair of ends 22, 24 of the arm segments 20. This pattern is repeated for each of the joints 46 of this configuration.

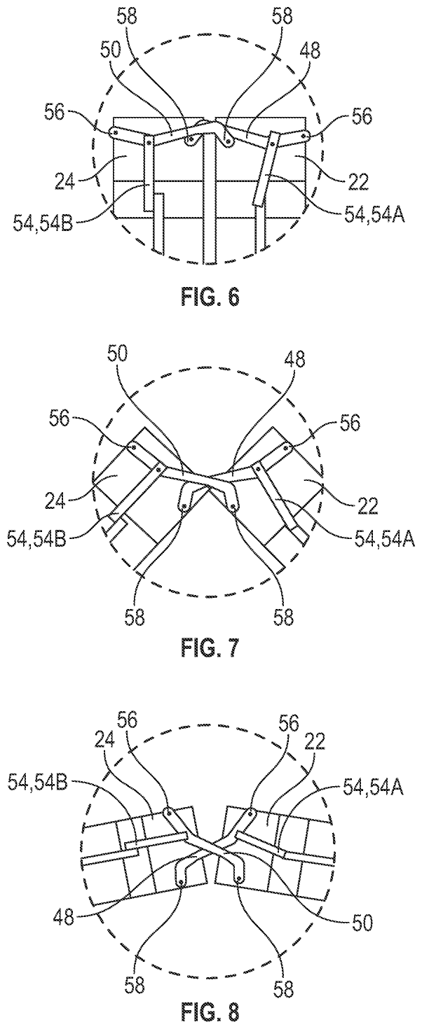

When the first connector 48 and the second connector 50 are configured as the links, the links cross each other as best shown in FIGS. 6-8. FIGS. 6-8 illustrate movement of the links from the retracted state to the extended state, in which, FIG. 6 is the retracted state, FIG. 7 is the extended state prior to the articulating arm reaching a final location relative to the aircraft, and FIG. 8 is when the final location of the articulating arm is attained to perform the task with the aircraft. Therefore, the articulating arm may extend to a fully extended state, but when the articulating arm is in the fully extended state, the ends 22, 24 of the arm segments 20 are not parallel to each other, which provides stability to the articulating arm. It is to be appreciated that the articulating arm may extend outwardly farther than illustrated in FIG. 1, and the figures are for illustrative purposes.

Also, as best shown in FIGS. 6-8 and 10, the first connector 48 and the second connector 50 may be attached to the first side 28 of the respective arm segments 20. Each of the first connectors 48 and each of the second connectors 50 may include a first distal end 56 and a second distal end 58 spaced apart from each other. As best shown in FIG. 10, in this configuration, the first distal end 56 of the first connector 48 is attached to one of the arm segments 20 (a first arm segment 20A for illustrative purposes) and the second distal end 58 of the first connector 48 is attached to another one of the arm segments 20 (a second arm segment 20B for illustrative purposes) such that the first connector 48 crosses between adjacent arm segments 20. Similarly, the first distal end 56 of the second connector 50 is attached to the another one of the arm segments 20 (the second arm segment 20B) and the second distal end 58 of the second connector 50 is attached to the one of the arm segments 20 (the first arm segment 20A) such that the second connector 50 crosses between the adjacent arm segments 20. More specifically, as best shown in FIGS. 6-8 and 10, the first distal end 56 and the second distal end 58 of each of the connectors 48, 50 are mounted on respective connector posts 60 of the respective arm segments 20 to transfer movement across the respective arm segments 20.

Continuing with FIGS. 5-8 and 10, one of the links 54 is attached to the first connector 48 between the first distal end 56 and the second distal end 58, and another one of the links 54 is attached to the second connector 50 between the first distal end 56 and the second distal end 58. More specifically, a first link 54A may be attached to the first connector 48 of the first joint 46A between the distal ends 56, 58 of the first connector 48 of the first joint 46A such that the first link 54 constrains relative movement of the respective arm segments 20, and a second link 54B may be attached to the second connector 50 of the second joint 46B between the distal ends 56, 58 of the second connector 50 of the second joint 46B such that the second link 54B constrains relative movement of the respective arm segments 20. As shown in FIG. 10, the arrangement of the links 54 at adjacent ends of a pair of the arm segments 20 may be different from each other, and in other configurations, the arrangement of the links 54 at adjacent ends of the pair of the arm segments 20 may be the same. It is to be appreciated that the links 54 of FIG. 5 are simplified and schematically shown, and would be connected per the details of FIG. 11.

The configuration of the connector posts 60 and the links 54 attached to the first connector 48 and the second connector 50, cooperate to constrain relative movement of the arm segments 20 at that respective joint 46. The arrows A of FIG. 11 illustrate the direction of movement of the respective links 54 as the articulating arm moves in the extended state. It is to be appreciated that the direction of the arrows A in FIG. 11 would be reversed when the articulating arm moves toward the retracted state.

Continuing with the configuration of FIGS. 5-11, each of the arm segments 20 may define a plurality of apertures 62 (see FIG. 10). For example, one of the apertures 62 of each of the arm segments 20 may be disposed proximal to the first end 22 of the respective arm segments 20, and another one of the apertures 62 of each of the arm segments 20 may be disposed proximal to the second end 24 of the respective arm segments 20. Part of one of the links 54 is disposed through one of the apertures 62 and part of another one of the links 54 is disposed through another one of the apertures 62 to connect the respective links 54 to the respective joints 46.

As discussed above, the second side 30 of each of the arm segments 20 may face the ground 32. Therefore, as shown in FIG. 11, part of the links 54 may be disposed along the second side 30 of the respective arm segments 20 such that a portion of the links 54 are hidden beneath the respective arm segments 20 relative to the first side 28 of the respective arm segments 20. Therefore, as shown in FIG. 11, the links 54 that are disposed through the respective apertures 62 have a part disposed above the first side 28 of the respective arm segments 20 and a part disposed below the second side 30 of the respective arm segments 20.

In certain configurations, each of the arm segments 20 may include a connection point 64 or a plurality of connection points 64 disposed between the first end 22 and the second end 24 of the respective arm segments 20. The links 54 are connected to each other through the joints 46 to translate motion between the arm segments 20. A first set of links 54 may be attached to each other along one of the arm segments 20, and a second set of links 54 may be attached to each other along another one of the arm segments 20. The first set of links 54 and the second set of links 54 are coupled together via the first connector 48 and the second connector 50 at each of the joints 46. The first set of links 54 of the respective arm segments 20 may be coupled together at the connection point 64 to allow the desired motion.

Continuing with FIG. 11, the at least one of the links 54 disposed through one of the apertures 62 for each of the arm segments 20 may be attached to the respective arm segments 20 at the pivot 66 is fixed to the respective arm segments 20 to allow rotation of that link 54 about the pivot 66. Therefore, referring to FIG. 11, each of the arm segments 20 have one pivot 66, and thus, one of the links 54 is rotatably attached to each of the arm segments 20 via that pivot 66, and this configuration is repeated for the desired number of the arm segments 20. The pivot 66 of the respective arm segment 20 is fixed to the respective arm segment 20 to allow rotation of that link 54. The first set of links 54 may be coupled together at the pivots 66 to allow the desired motion. Therefore, synchronous motion of the arm segments 20 may be achieved. Any suitable number of sets of links 54 may be used, but for illustrative purposes, FIG. 11 illustrates four links 54 in the first set of links 54 and four links 54 in the second set of links 54.

Referring to FIG. 5, the first link 54A may be part of the first set of links 54, and thus, the first link 54A of the first set of links 54 may be attached to the first connector 48 of the first joint 46A between the distal ends 56, 58 of the first connector 48 of the first joint 46A such that the first link 54A constrains relative movement of the respective arm segments 20. Similarly, the second link 54B may be part of the first set of links 54, and thus, the second link 54B of the first set of links 54 may be attached to the second connector 50 of the second joint 46B between the distal ends 56, 58 of the second connector 50 of the second joint 46B such that the second link 54B constrains relative movement of the respective arm segments 20.

Turning to the configuration of the links 54, the first connector 48, and the second connector 50 of FIGS. 12 and 13, the links 54 between the joints 46 and the connectors 48, 50 are configured differently than the links 54 of FIGS. 5-11. In this configuration, the first connector 48 and the second connector 50 cross each other to generally define a X-configuration, which may also be referred to as a 4-bar linkage arranged in an anti-parallelogram configuration or arranged in a parallelogram configuration. Furthermore, the links 54 for each of the arm segments 20 may be disposed substantially parallel to each other. That is, one of the arm segments 20 may include two links 54 that are substantially parallel to each other, and so on for the number of arm segments 20 being used. It is to be appreciated that the configuration of FIGS. 12 and 13 may be referred to as a parallelogram/anti-parallelogram configuration, and this configuration provides the arm segments 20 with the ability to produce the same angle θx between the arm segments 20, which results in the arm segments 20 moving relative to each other with the single degree-of-freedom.

Ends of the links 54 are attached to the respective joint 46 via the respective first connector 48 and the respective second connector 50. Specifically, each of the links 54 of one of the arm segments 20 (a first arm segment 20A) are pinned to the first connector 48 at different locations of one of the joints 46 (the first joint 46A). For example, referring to FIG. 12, a first link 54C of the first arm segment 20A is attached to the first connector 48 of the first joint 46A and the first link 54C of the first arm segment 20A is attached to the second connector 50 of the first joint 46A. In addition, a second link 54D of the first arm segment 20A is attached to the first connector 48 of the first joint 46A, in which the second link 54D is spaced from the first link 54C of the first arm segment 20A. Furthermore, a first link 54E of a second arm segment 20B is attached to the first connector 48 of the first joint 46A and the first link 54E of the second arm segment 20B is attached to the second connector 50 of the first joint 46A. In addition, a second link 54F of the second arm segment 20B is attached to the second connector 50 of the first joint 46A, in which the second link 54F is spaced from the first link 54E of the second arm segment 20B. The connectors 48, 50, the first link 54C, 54E, and the second link 54D, 54F are attached to each other at respective pivot connection points 68, and thus, constrains relative movement of the respective arm segments 20 due to the location of the pivot connection points 68. Therefore, the first link 54C of the first arm segment 20A has two pivot connection points 68 proximal to one of the ends 22, 24 of the first arm segment 20A, but the second link 54D of the first arm segment 20A has one pivot connection point 68 proximal to that same end of the first arm segment 20A. This pattern is repeated for the desired number of joints 46.

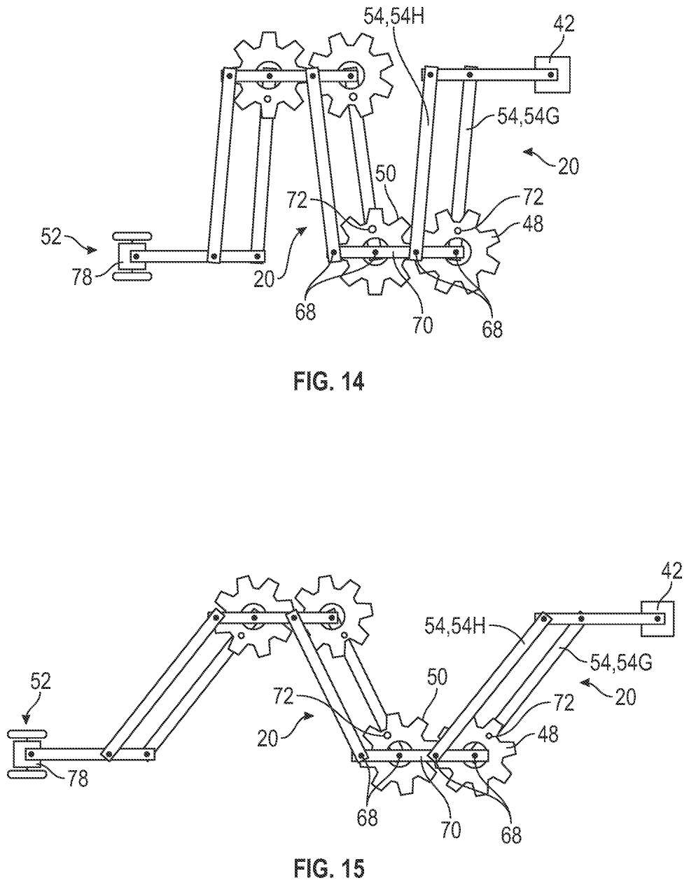

Turning to the configuration of the links 54, the first connector 48, and the second connector 50 of FIGS. 14 and 15, the joints 46 are configured differently than the configurations of FIGS. 5 and 12, but the links 54 are disposed substantially parallel to each other similar to the configuration of FIG. 12. Therefore, the configuration of FIGS. 14 and 15 performs similarly to the 4-bar linkage (e.g., anti-parallelogram) discussed above. In this configuration, the first connector 48 and the second connector 50 may be configured as gears that mesh together, or may be configured as pulleys cooperating with belts or cables therebetween. Each of the arm segments 20 may include a first link 54H and a second link 54G. In addition, the links 54 may further include an intermediate link 70 attached to the respective gears, and also the intermediate link 70 is attached to ends of the respective links 54, such as the first link 54G and the second link 54H. The gears are attached or pinned to the respective links 54G, 54H at fixed points 72 to constrain relative movement. For example, the intermediate link 70, the first link 54G, and the second link 54H are attached to each other at respective pivot connection points 68, and thus, constrains relative movement of the respective arm segments 20 due to the location of the pivot connection points 68. In addition, the gears are disposed between the first link 54G and the second link 54H of the respective arm segments 20, and each of the gears surround one of the pivot connection points 68 along the intermediate link 70. It is to be appreciated that the configuration of FIGS. 14 and 15 may be referred to as a multi-gear configuration.

As discussed above, movement of the articulating arm is relative to the anchor point 42. Referring to FIGS. 3 and 4, the distal arm segment 38 may be free to move in any direction relative to the anchor point 42 to move the articulating arm. To move the distal arm segment 38 to the desired location, the articulating transport assembly 12 may include the transport actuator 52 attached to one of the arm segments 20, and in certain configurations, attached to the distal arm segment 38. The transport actuator 52 is configured to move the articulating arm relative to the anchor point 42. Therefore, the transport actuator 52 may cause the arm segments 20 to move between the retracted state and the extended state, as well as rotate the articulating arm relative to the pivot axis 44. By utilizing the transport actuator 52 described herein, manually or independently moving the arm segments 20 may be eliminated.

By locating the transport actuator 52 along the distal arm segment 38, the transport actuator 52 may cause movement of all of the arm segments 20, and thus, there is no need to include additional transport actuators 52 to independently control one or more of the arm segments 20 in order to move the articulating arm. Therefore, in certain configurations, it is desirable to utilize a single transport actuator 52, and thus, the transport actuator 52 is coupled to the distal arm segment 38 so that the movement of the distal arm segment 38 will control movement of the other arm segments 20. By utilizing the single transport actuator 52, hardware requirements may be reduced. Also, in certain configurations, the pivot point 42 may be a fixed location such that the articulating arm moves relative to the pivot point 42, via the single transport actuators 52. It is to be appreciated that, optionally, additional transport actuators 52 may be used if desired.

In another configuration, the entire articulating arm may be movable using multiple transport actuators 52, such as one disposed along the distal arm segment 38 as discussed above, and another one disposed along the proximal arm segment 36. For example, the articulating arm may be stored in one location, and when the articulating arm is to be used, the entire articulating arm may be moved, via the multiple transport actuators 52 to a location where normal operation will occur to extend and retract the object 14, e.g., the cable, relative to the moveable platform 16, e.g., the aircraft. Once the articulating arm reaches the desired location to normally operate, the proximal arm segment 36 will be fixed relative to the ground and act as the anchor point 42. For example, the transport actuator 52 of the proximal arm segment 36 may act as the anchor, which allows the other transport actuator 52 to move the articulating arm relative to the transport actuator 52 of the proximal arm segment 36. It is to be appreciated that for any of the configurations discussed herein, the fixed anchor point 42 may be replaced with another transport actuator 52 that may act as the anchor when normal operation is to occur.

The transport actuator 52 may be controlled to extend the articulating arm out to the aircraft or to retract the articulating arm. The transport actuator 52 may be controlled manually or automatically. Referring to FIG. 4, the evenly spaced dashed line B represents an alignment region for the distal arm segment 38 relative to the aircraft, in which the distal arm segment 38 reaches the desired orientation when the central axis 26 of the distal arm segment 38 is coaxial with the dashed line B. The transport actuator 52 may be operated manually by an operator through a hand-held remote 74 to control the speed and direction of the movement of the articulating arm, and in particular, to position the distal arm segment 38 in the desired alignment region along the dashed line B. Therefore, the hand-held remote 74 may be in communication with the transport actuator 52 so that the hand-held remote 74 may control the transport actuator 52.

In other configurations, a controller 76 may be in communication with the transport actuator 52 to automatically control movement of the articulating arm. In this configuration, the operator may operate this automated control by one or more switches, toggles, buttons, etc. For example, when the operator deploys a selected switch/toggle/button, the controller 76 automatically controls movement of the transport actuator 52 based on the request via the operator.

The controller 76 is configured to execute the instructions from a memory M, via a processor P. For example, the controller 76 may be a host machine or distributed system, e.g., a computer such as a digital computer or microcomputer, and, as the memory M, tangible, non-transitory computer-readable memory such as read-only memory (ROM) or flash memory. The controller 76 may also have random access memory (RAM), electrically erasable programmable read-only memory (EEPROM), a high-speed clock, analog-to-digital (A/D) and/or digital-to-analog (D/A) circuitry, and any required input/output circuitry and associated devices, as well as any required signal conditioning and/or signal buffering circuitry. Therefore, the controller 76 may include all software, hardware, memory M, algorithms, connections, sensors, etc., necessary to control the transport actuator 52. As such, a control method operative to control the transport actuator 52 may be embodied as software or firmware associated with the controller 76. As one non-limiting example, the transport actuator 52 may be controlled, via the controller 76, using inverse kinematics and/or forward kinematics, and the controller 76 may store in the memory M the desired locations to move the articulating arm relative to the aircraft. In this configuration, for example, the controller 76 may be activated, and then the controller 76 automatically moves the distal arm segment 38 to the dashed line B of FIG. 4. Optionally, one or more sensors may be disposed in any suitable location along the articulating arm, which are in communication with the controller 76 and/or the hand-held remote 74; the sensors may provide information about the articulating arm, such as orientation of the arm segments 20, location of the anchor point 42, rotational information of the articulating arm, information about the transport actuator 52, and/or distance between the articulating arm and the movable platform 16, etc.

The transport actuator 52 may include one or more motors 78 and one or more wheels 80 movably coupled to the one or more motors 78 such that the one or more motors 78 drive the one or more wheels 80. The one or more wheels 80 may be coupled to the distal arm segment 38 such that the one or more wheels 80 are disposed between the ground 32 and the distal arm segment 38. As non-limiting examples, the motor(s) 78 may be an electric motor, a gas-powered motor, or any other suitable actuator to drive movement of the one or more wheels 80, and thus, drive movement of the articulating arm relative to the pivot axis 44. Regardless of whether the transport actuator 52 is being controlled manually or automatically, the motor(s) 78 and/or the one or more wheels 80 may be locked (using the hand-held remote 74 or the controller 76) to secure the articulating arm in the desired location. When using a plurality of the transport actuators 52, each of the transport actuators may include the motor(s) 78, the wheels 80, and lock(s) to secure the articulating arm in the desired location, as described herein. It is to be appreciated that the wheels 80 may be any suitable configuration, and non-limiting examples includes round wheels, tracks, mecanum wheels, omni wheels, or swerve-drive assemblies to allow holonomic movement of the transport actuators 52. Furthermore, the motor(s) 78 may be any suitable configuration, and non-limiting examples of the motor(s) 78 may include electric motor, electro-mechanical motor, etc.

It is desirable to cover the first connector 48, the second connector 50, the links 54, etc., as well as provide a surface to rest the flexible structure, i.e., the cable, across. By covering these components, the cable does not interfere with the function of the articulating arm during movement. Therefore, each of the arm segments 20 may include a platform 82 (see FIGS. 2-4 and 18) attached to the first side 28, and the platform 82 is configured to support the flexible structure that extends across more than one of the arm segments 20. That is, the platform 82 of each of the arm segments 20 is configured to support the flexible structure across each of the arm segments 20 to transport the flexible structure. The platform 82 as illustrated in FIGS. 2-4 and 18 may be utilized for any of the configurations herein.

In certain configurations, the first connector 48 and the second connector 50 of each of the arm segments 20 are attached to the first side 28 of the respective arm segments 20. The platform 82 of each of the arm segments 20 may be attached to the first side 28 of the respective arm segments 20 so that the first connector 48 and the second connector 50 of each of the arm segments 20 are disposed between the first side 28 and the platform 82. That is, the first connector 48 and the second connector 50 of each of the arm segments 20 may be covered via the respective platform 82 when the articulating arm is in the extended state so that the cable does not get caught in the respective joints 46 during movement of the articulating arm.

Referring to FIG. 18, it is to be appreciated that one or more of the first end 22 and the second end 24 of the arm segments 20 may optionally include a support structure 84 to support the cable across the respective joints 46 so that the cable does not get caught in the respective joints 46 during movement of the articulating arm. Non-limiting examples of the support structure 84 may include a sleeve, an e-chain, a cable wrap sleeve, etc.

Once the articulating arm is disposed in the desired position relative to the aircraft, it is desirable to lift a coupling end 86 of the flexible structure relative to the port 18 of the aircraft. Therefore, referring to FIGS. 16-22, the articulating transport assembly 12 may also include an end effector 88 coupled to the distal arm segment 38. The end effector 88 is configured to lift the flexible structure to the port 18 of the aircraft to minimize manually moving of the flexible structure. The end effector 88 is not shown in all of the figures to illustrate other features, but it is to be appreciated that the end effector as described in FIGS. 16-22 may be incorporated in any of the figures.

The end effector 88 may include a plurality of posts 90, and optionally, a coupler 92 coupled to one of the posts 90. The coupler 92 is configured to attach the flexible structure to the end effector 88. Therefore, during movement of the cable toward the aircraft, the coupler 92 may assist in maintaining the coupling end 86 of the cable relative to the end effector 88. Once the desired position of the coupling end 86 of the cable is reached relative to the aircraft, the coupler 92 may optionally release the cable so that final engagement with the aircraft may be obtained. Optionally, one or more biasing members 93 may be coupled to the object 14 and the platform 82 to tension the object 14. That is, the biasing members 93 may partially constrain the object 14 to assist with preventing the object 14 from being caught on another structure.

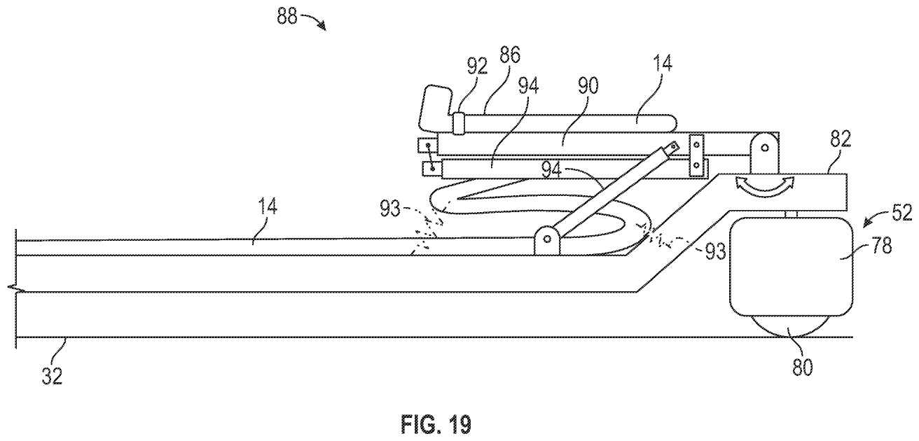

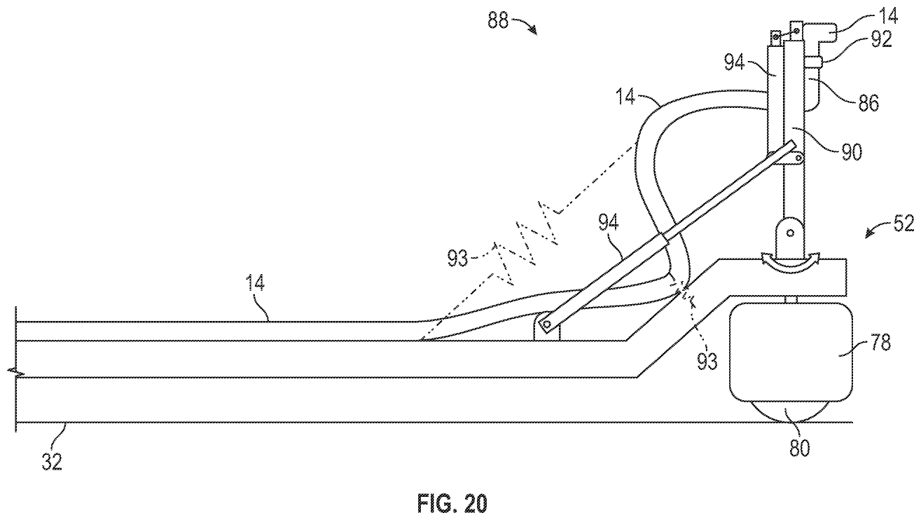

Referring to FIGS. 19 and 20, the articulating transport assembly 12 may further include an actuator 94 coupled to the end effector 88. The actuator 94 is configured to move the end effector 88 between a stored state (see FIGS. 16-19) in which the end effector 88 is retracted and a partial deployed state (see FIGS. 20 and 21) and a final deployed state (see FIG. 22) in which the posts 90 are movable upright relative to the platform 82 to lift the flexible structure away from the platform 82. Therefore, the flexible structure, e.g., the object 14, may be coiled on the platform 82 with enough slack to allow the flexible structure to be lifted to the desired location. The actuator 94 is also configured to move at least one of the posts 90 in the direction of arrow W relative to the other posts 90 to lift the flexible structure from the partial deployed state to the final deployed state which moves the flexible structure farther away from the platform 82 than the partial deployed state. Once the cable is in the final deployed state, the cable may be coupled to the aircraft via the port 18. When the cable is disconnected from the aircraft, the coupling end 86 of the cable may be repositioned on the end effector 88, and the actuator 94 may retract the posts 90 in an opposite direction from the arrow W back to the partial deployed state, and then retract the end effector 88 back to the stored state. Control of the actuator 94 for the end effector 88 may be manually using the hand-held remote 74 or automatically using the controller 76 as discussed above, and thus, the hand-held remote 74 and the controller 76 may be in communication with the actuator 94 of the end effector 88. The actuator 94 may be any suitable configuration to raise and lower the flexible structure, and non-limiting examples of the actuator 94 may include pneumatic actuator, hydraulic actuator, electromechanical actuator, mechanical actuator, etc. In addition, optionally, one or more sensors may be disposed along the end effector 88, which are in communication with the controller 76 and/or the hand-held remote 74; the sensors may provide information about the orientation of the end effector 88.

An example operation of the articulating arm will be discussed next. The below discussion assumes that the proximal arm segment 36 has been anchored to the ground at one end. The operator may select an automatic mode or manual mode using the controller 76 or the hand-held remote 74 to operate the articulating arm.

If the operator selects the automatic mode, the controller 76 automatically controls the articulating arm. Location data stored via the controller 76 may be used, or location data from an offline simulation may be used. Again, the controller 76 may use inverse kinematics and/or forward kinematics equations to calculate the required angles θₓ, θₚ, θₘ, and then execute movement of the articulating arm. The controller 76 signals the transport actuator 52 to move the articulating arm accordingly to the calculation. The sensors may be used to determine the proximity of distal arm segment 38 relative to the movable platform 16, such as the aircraft. When the desired location of the distal arm segment 38 is reached, the controller 76 signals the transport actuator 52 to lock the one or more wheels 80 to prevent movement of the distal arm segment 38 relative to the ground. Next, the controller 76 signals the end effector 88 to raise the object 14, such as the flexible structure, relative to the aircraft. When the controller 76 determines that the desired location is reached along the aircraft, such as the port 18, then the controller 76 signals the end effector 88 to stop moving. The operator may disconnect the coupler 92 and then the operator may connect the flexible structure to the port 18. When the aircraft is ready for another stage, the operator may disconnect the flexible structure from the port 18 and reattach the flexible structure to the coupler 92. Then, the end effector 88 and the articulating arm may be retracted automatically using the controller 76.

If the operator selects the manual mode, the operator manually controls the movement of the articulating arm. Therefore, the operator uses the hand-held remote 74 to operate the transportation actuator 52. The controller 76 may store the route information from the manual operation of the articulating arm to be used at another time. The sensors may be used to determine the proximity of distal arm segment 38 relative to the movable platform 16, such as the aircraft. When the desired location of the distal arm segment 38 is reached, the operator uses the hand-held device 74 to signal the transport actuator 52 to lock the one or more wheels 80 to prevent movement of the distal arm segment 38 relative to the ground 32. Next, the operator uses the hand-held remote 74 to signal the end effector 88 to raise the object 14, such as the flexible structure, relative to the aircraft. When the desired location is reached along the aircraft, such as the port 18, then the operator uses the hand-held remote 74 to stop movement of the end effector 88. The operator may disconnect the coupler 92 and then the operator may connect the flexible structure to the port 18. When the aircraft is ready for another stage, the operator may disconnect the flexible structure from the port 18 and reattach the flexible structure to the coupler 92. Then, the operator may retract the end effector 88 and the articulating arm accordingly using the hand-held remote 74.

While the best modes and other configurations for carrying out the disclosure have been described in detail, those familiar with the art to which this disclosure relates will recognize various alternative designs and configurations for practicing the disclosure within the scope of the appended claims. Furthermore, the configurations shown in the drawings or the characteristics of various configurations mentioned in the present description are not necessarily to be understood as configurations independent of each other. Rather, it is possible that each of the characteristics described in one of the examples of a configuration can be combined with one or a plurality of other desired characteristics from other configurations, resulting in other configurations not described in words or by reference to the drawings. Accordingly, such other configurations fall within the framework of the scope of the appended claims.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware that enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The following Clauses provide some example configurations of the articulating transport assembly and the transport system as disclosed herein.

Clause 1: An articulating transport assembly for a movable platform, the assembly comprising: a plurality of arm segments connected to each other and movable to a retracted state and an extended state to define an articulating arm; and a plurality of joints each including a first connector and a second connector disposed between a respective pair of the arm segments to join the arm segments such that the arm segments move relative to each other with a single degree-of-freedom between the retracted state and the extended state.

Clause 2: The articulating transport assembly as set forth in clause 1 further including a plurality of links, with at least one of the plurality of links attached to the first connector of one of the joints and attached to the second connector of another one of the joints such that the links constrain relative motion between the arm segments.

Clause 3: The articulating transport assembly as set forth in one of clauses 1 or 2 wherein: each of the arm segments defines a plurality of apertures; and part of one of the links is disposed through one of the apertures and part of another one of the links is disposed through another one of the apertures to connect the respective links to the respective joints.

Clause 4: The articulating transport assembly as set forth in any one of the preceding clauses wherein: the arm segments include a first side and a second side opposing the first side; the first connector and the second connector are attached to the first side of the respective arm segments; and part of the links are disposed along the second side of the respective arm segments such that a portion of the links are hidden beneath the respective arm segments relative to the first side of the respective arm segments.

Clause 5: The articulating transport assembly as set forth in any one of the preceding clauses wherein: the plurality of joints includes a first joint and a second joint each including the respective first connector and the respective second connector; the first connector and the second connector cross each other over the first joint such that the first connector is movably attached to a first pair of ends of the arm segments and the second connector is movably attached to the first pair of ends of the arm segments; and another first connector and another second connector cross each other over the second joint such that the first connector is movably attached to a second pair of ends of the arm segments and the second connector is movably attached to the second pair of ends of the arm segments.

Clause 6: The articulating transport assembly as set forth in any one of the preceding clauses: further including a first set of links attached to each other along one of the arm segments, and a second set of links attached to each other along another one of the arm segments; and wherein a first link of the first set of links is attached to the first connector of the first joint between ends of the first connector of the first joint such that the first link constrains relative movement of the respective arm segments, and a second link of the first set of links is attached to the second connector of the second joint between ends of the second connector of the second joint such that the second link constrains relative movement of the respective arm segments.

Clause 7: The articulating transport assembly as set forth in any one of the preceding clauses wherein: each of the arm segments includes a first end and a second end opposing each other along a central axis; the central axis of each of the arm segments along the respective joints are disposed substantially parallel to each other when the articulating arm is in the retracted state; and the central axis of each of the arm segments along the respective joints are disposed at an angle not equal to zero degrees and not equal to one-hundred eighty degrees relative to each other when the articulating arm is in the extended state.

Clause 8: The articulating transport assembly as set forth in any one of the preceding clauses wherein: each of the arm segments includes a first end and a second end opposing each other along a central axis; and the central axis of each of the arm segments along the respective joints are disposed transverse to each other when the articulating arm is in the extended state.

Clause 9: The articulating transport assembly as set forth in any one of the preceding clauses wherein the angle at each of the joints are substantially equal to each other during movement of the articulating arm between the retracted state and the extended state.

Clause 10: The articulating transport assembly as set forth in any one of the preceding clauses: wherein one of the arm segments is defined as a proximal arm segment and another one of the arm segments is defined as a distal arm segment; and further including an anchor point coupled to the proximal arm segment.

Clause 11: The articulating transport assembly as set forth in any one of the preceding clauses wherein the anchor point defines a pivot axis, and the proximal arm segment is coupled to the anchor point such that the proximal arm segment is rotatable about the pivot axis to selectively change a location of the distal arm segment relative to the anchor point.

Clause 12: The articulating transport assembly as set forth in any one of the preceding clauses further including a transport actuator attached to the distal arm segment and configured to move the articulating arm relative to the anchor point.

Clause 13: The articulating transport assembly as set forth in any one of the preceding clauses wherein: at least one of the arm segments is disposed between the proximal arm segment and the distal arm segment; the at least one of the arm segments disposed between the proximal arm segment and the distal arm segment is defined as an intermediate arm segment; each of the arm segments has a length; and the length of the proximal arm segment and the distal arm segment are different than the length of the intermediate arm segment.

Clause 14: The articulating transport assembly as set forth in any one of the preceding clauses wherein: each of the arm segments include a first side and a platform attached to the first side, and the platform is configured to support a flexible structure that extends across more than one of the arm segments; each of the arm segments include a second side opposing the first side of the respective arm segments; and the first connector and the second connector of each of the arm segments are attached to the first side of the respective arm segments.

Clause 15: The articulating transport assembly as set forth in any one of the preceding clauses further including at least one ground support attached to the second side of each of the arm segments to support the arm segments.

Clause 16: The articulating transport assembly as set forth in any one of the preceding clauses wherein each of the arm segments includes a platform configured to support a flexible structure across each of the arm segments to transport the flexible structure.

Clause 17: The articulating transport assembly as set forth in any one of the preceding clauses: wherein one of the arm segments is defined as a proximal arm segment and another one of the arm segments is defined as a distal arm segment; further including an end effector coupled to the distal arm segment, and the end effector includes a plurality of posts and a coupler coupled to one of the posts and configured to attach the flexible structure to the end effector; and further including an actuator coupled to the end effector, and the actuator is configured to move the end effector between a stored state in which the end effector is retracted and a partial deployed state and a final deployed state in which the posts are movable upright relative to the platform to lift the flexible structure away from the platform, and the actuator is configured to move at least one of the posts relative to the other posts to lift the flexible structure from the partial deployed state to the final deployed state which moves the flexible structure farther away from the platform than the partial deployed state.

Clause 18: The articulating transport assembly as set forth in any one of the preceding clauses wherein the first connector and the second connector of each of the arm segments is defined as a link.

Clause 19: The articulating transport assembly as set forth in any one of clauses 1-17 wherein the first connector and the second connector of each of the arm segments is defined as a gear.

Clause 20: A transport system for moving a flexible structure, the system comprising: an aircraft including a port configured to connect to the flexible structure; and an articulating transport assembly including: a plurality of arm segments connected to each other and movable to a retracted state and an extended state to define an articulating arm configured to support and move the flexible structure relative to the aircraft; and a plurality of joints each including a first connector and a second connector disposed between a respective pair of the arm segments to join the arm segments such that the arm segments move relative to each other with a single degree-of-freedom between the retracted state and the extended state.

What is claimed is:

1. An articulating transport assembly for a movable platform, the assembly comprising:
a plurality of arm segments connected to each other and movable to a retracted state and an extended state to define an articulating arm; and
a plurality of joints each including a first connector and a second connector disposed between a respective pair of the arm segments to join the arm segments such that the arm segments move relative to each other with a single degree-of-freedom between the retracted state and the extended state.

2. The articulating transport assembly as set forth in claim 1 further including a plurality of links, with at least one of the plurality of links attached to the first connector of one of the joints and attached to the second connector of another one of the joints such that the links constrain relative motion between the arm segments.

3. The articulating transport assembly as set forth in claim 2 wherein:
each of the arm segments defines a plurality of apertures; and
part of one of the links is disposed through one of the apertures and part of another one of the links is disposed through another one of the apertures to connect the respective links to the respective joints.

4. The articulating transport assembly as set forth in claim 3 wherein:
the arm segments include a first side and a second side opposing the first side;
the first connector and the second connector are attached to the first side of the respective arm segments; and
part of the links are disposed along the second side of the respective arm segments such that a portion of the links are hidden beneath the respective arm segments relative to the first side of the respective arm segments.

5. The articulating transport assembly as set forth in claim 1 wherein:
the plurality of joints includes a first joint and a second joint each including the respective first connector and the respective second connector;
the first connector and the second connector cross each other over the first joint such that the first connector is movably attached to a first pair of ends of the arm segments and the second connector is movably attached to the first pair of ends of the arm segments; and
another first connector and another second connector cross each other over the second joint such that the first connector is movably attached to a second pair of ends of the arm segments and the second connector is movably attached to the second pair of ends of the arm segments.

6. The articulating transport assembly as set forth in claim 5:
further including a first set of links attached to each other along one of the arm segments, and a second set of links attached to each other along another one of the arm segments; and
wherein a first link of the first set of links is attached to the first connector of the first joint between ends of the first connector of the first joint such that the first link constrains relative movement of the respective arm segments, and a second link of the first set of links is attached to the second connector of the second joint between ends of the second connector of the second joint such that the second link constrains relative movement of the respective arm segments.

7. The articulating transport assembly as set forth in claim 5 wherein:
each of the arm segments includes a first end and a second end opposing each other along a central axis;
the central axis of each of the arm segments along the respective joints are disposed substantially parallel to each other when the articulating arm is in the retracted state; and
the central axis of each of the arm segments along the respective joints are disposed at an angle not equal to zero degrees and not equal to one-hundred eighty degrees relative to each other when the articulating arm is in the extended state.

8. The articulating transport assembly as set forth in claim 5 wherein:
each of the arm segments includes a first end and a second end opposing each other along a central axis; and
the central axis of each of the arm segments along the respective joints are disposed transverse to each other when the articulating arm is in the extended state.

9. The articulating transport assembly as set forth in claim 7 wherein the angle at each of the joints are substantially equal to each other during movement of the articulating arm between the retracted state and the extended state.

10. The articulating transport assembly as set forth in claim 1:
wherein one of the arm segments is defined as a proximal arm segment and another one of the arm segments is defined as a distal arm segment; and
further including an anchor point coupled to the proximal arm segment.

11. The articulating transport assembly as set forth in claim 10 wherein the anchor point defines a pivot axis, and the proximal arm segment is coupled to the anchor point such that the proximal arm segment is rotatable about the pivot axis to selectively change a location of the distal arm segment relative to the anchor point.

12. The articulating transport assembly as set forth in claim 10 further including a transport actuator attached to the distal arm segment and configured to move the articulating arm relative to the anchor point.

13. The articulating transport assembly as set forth in claim 10 wherein:
at least one of the arm segments is disposed between the proximal arm segment and the distal arm segment;
the at least one of the arm segments disposed between the proximal arm segment and the distal arm segment is defined as an intermediate arm segment;
each of the arm segments has a length; and
the length of the proximal arm segment and the distal arm segment are different than the length of the intermediate arm segment.

14. The articulating transport assembly as set forth in claim 1 wherein:
each of the arm segments include a first side and a platform attached to the first side, and the platform is configured to support a flexible structure that extends across more than one of the arm segments;
each of the arm segments include a second side opposing the first side of the respective arm segments; and
the first connector and the second connector of each of the arm segments are attached to the first side of the respective arm segments.

15. The articulating transport assembly as set forth in claim 14 further including at least one ground support attached to the second side of each of the arm segments to support the arm segments.

16. The articulating transport assembly as set forth in claim 1 wherein each of the arm segments includes a platform configured to support a flexible structure across each of the arm segments to transport the flexible structure.

17. The articulating transport assembly as set forth in claim 16:
wherein one of the arm segments is defined as a proximal arm segment and another one of the arm segments is defined as a distal arm segment;
further including an end effector coupled to the distal arm segment, and the end effector includes a plurality of posts and a coupler coupled to one of the posts and configured to attach the flexible structure to the end effector; and
further including an actuator coupled to the end effector, and the actuator is configured to move the end effector between a stored state in which the end effector is retracted and a partial deployed state and a final deployed state in which the posts are movable upright relative to the platform to lift the flexible structure away from the platform, and the actuator is configured to move at least one of the posts relative to the other posts to lift the flexible structure from the partial deployed state to the final deployed state which moves the flexible structure farther away from the platform than the partial deployed state.

18. The articulating transport assembly as set forth in claim 1 wherein the first connector and the second connector of each of the arm segments is defined as a link.

19. The articulating transport assembly as set forth in claim 1 wherein the first connector and the second connector of each of the arm segments is defined as a gear.

20. A transport system for moving a flexible structure, the system comprising:
an aircraft including a port configured to connect to the flexible structure; and
an articulating transport assembly including:
a plurality of arm segments connected to each other and movable to a retracted state and an extended state to define an articulating arm configured to support and move the flexible structure relative to the aircraft; and
a plurality of joints each including a first connector and a second connector disposed between a respective pair of the arm segments to join the arm segments such that the arm segments move relative to each other with a single degree-of-freedom between the retracted state and the extended state.
